(19) United States
(12) Patent Application Publication
(10) Pub. No.: US 2010/0279137 A1
(43) Pub. Date: Nov. 4, 2010

(54) NOVEL HYBRID BINDER WITH NATURAL COMPOUNDS FOR LOW EMISSION PRODUCTS

(76) Inventors: Kristina Durkic, Lillestrom (NO); Wolfgang Heep, Woltersdorf (DE); Wolfgang Kantner, Schwarzenau (AT); Detlef Krug, Dresden (DE)

Correspondence Address: BIRCH STEWART KOLASCH & BIRCH, PO BOX 747, FALLS CHURCH, VA, 22040-0747, US

(21) Appl. No.: 12/377,567

(22) PCT Filed: Aug. 30, 2007
(86) PCT No.: PCT/IB07/02506

§ 371 Date: Apr. 13, 2009

Related U.S. Application Data
(60) Provisional application No. 60/841,222, filed on Aug. 31, 2006.

(51) Int. Cl. B32B 21/08; C08L 89/00; B32B 27/10; C08L 1/02

(52) U.S. Cl. 428/528; 525/54.1; 524/13; 428/530

(57) ABSTRACT

Resin compositions (A) and (B) are described: wherein resin composition (A) comprises a naturally occurring component or derivative thereof comprising protein, an aromatic hydroxyl compound-aldehyde resin and an amino resin, wherein the naturally occurring component or derivative thereof is chemically bound to the aromatic hydroxyl compound-aldehyde resin to form an ncPF resin and the naturally occurring component or derivative thereof is optionally chemically bound to the amino resin; wherein resin composition (B) comprises a condensation product of a naturally occurring component or derivative thereof, an aromatic hydroxyl compound-aldehyde resin and at least 20 wt % of urea based on the total mass of the resin composition, wherein at least 50 wt % of the naturally occurring component or derivative thereof is chemically bound directly or indirectly to the aromatic hydroxyl compound-aldehyde resin (ncPF), and wherein the naturally occurring component or derivative thereof comprises protein. The resin compositions can be used as a binder for lignocellulosic or cellulosic materials which have an excellent combination of low formaldehyde emissions and high strength. Also described are low formaldehyde emissions wood products comprising unique binder combinations.

### TECHNICAL FIELD OF THE INVENTION

The present disclosure relates to binders and lignocellulosic or cellulosic materials comprising said binders.

### BACKGROUND

One of the most used type of adhesives in the industries such as wood-based industry, insulation, paper saturations, coatings and others, are formaldehyde-based adhesives like amino- and phenol-formaldehyde. Due to worldwide availability of the raw materials and excellent performance of the adhesives in the various applications, there is a wide range of the amino and phenol-formaldehyde products from powder to liquid form, high to low viscous properties, different molar ratio, etc. The choice of the adhesive properties will depend on the properties the product in application has to meet and the standard requirements it has to fulfil. However, one common characteristic to all the adhesives in the amino-formaldehyde family is that reactivity and formaldehyde emission are proportional and are greatly dependent on the formaldehyde to amino molar ratio and to a lesser extent, the formaldehyde to phenol molar ratio. In practice this means that to meet different standards requiring lower formaldehyde emission, the ratio of the formaldehyde to amino and formaldehyde to phenol will be decreased, which normally also results in a decreased efficiency under the same running conditions.

Comparing amino- and phenol-formaldehyde resins for use as binders, the previous is more efficient, but with higher tendency towards hydrolysis and a higher formaldehyde emission of the product. This is in distinction to phenol-formaldehyde resins which give lower formaldehyde emission products than amino-formaldehyde resins, but at the cost of lowering the production efficiency. To overcome low adhesive performance, it is known practice to use the materials such as natural components to modify the properties of the adhesives. However, modification of phenol- and amino formaldehyde resin by addition of natural components might cause significant detrimental changes in physical and/or chemical properties (such as viscosity or buffer capacity) compared to the original adhesive, to such an extent as to limit the potential applications of the modified adhesive. Such a system is described in U.S. Pat. No. 3,701,743 (hereinafter “the '743 patent”) to Horowitz et al. The '743 patent describes a resin mix for plywood consisting of an urea formaldehyde resin, of a PF resin, and of an amylaceous extender like wheat flour, starch, or tapioca. The amylaceous extender also might be replaced by a proteinaceous extender like soya flour or dried blood, which is taught to shorten the high temperature set time of the adhesive. However, the final product is merely a physical mixture of the proteinaceous extender, the PF resin and the urea formaldehyde resin wherein the proteinaceous extender provides added bulk to the adhesive. The adhesive product of the '743 patent is intended to have sprayability and good cold tack. The cold tack property is especially important when producing plywood, so as to enable the so-called prepressing step which gives a physical (but not chemical) solidifying of the glue line between two veneer plies and giving the possibility of intermediate storage of the prepressed stack of veneers prior to the heat pressing step. Another aim of the '743 patent is the avoidance of bleed through of the outer face veneer. However, the final mixture has a high viscosity of 2500-5000 mPa·s which is so high as to render the adhesive undesirable for applications such as particleboard, MDF (medium density fiberboard), and OSB (oriented strand board).

The object of the present invention is to overcome the above-described problems of the known binders by providing a new hybrid binder comprising a natural component. This new hybrid binder allows for the formation of high solids coupled with a low viscosity. Such compositions have good sprayability and a lighter color of the hardened bond line, which are desired in such operations as in the production of fiberboards.

The binder's composition is balanced to provide fast cross-linking and a high degree of hardening, and with the subsequently low formaldehyde emission.

Further, the inventive binder has good reactivity and achieves the low formaldehyde emitting products by having a sufficient amount of formaldehyde available for fast cross-linking at a high degree into hydrolysis resistible network and an efficient formaldehyde scavenger available at the right time in the application.

The widening of the raw material portfolio also can have a commercial advantage in lowering the raw material costs of adhesives as used for purposes as for adhesive mixes as described in this patent application and can help to reduce the dependence on the existing raw material markets.

### SUMMARY OF THE INVENTION

The present invention is drawn to a low formaldehyde emission resin composition for use as a binder of lignocellulosic or cellulosic materials and comprises a condensation product of a naturally occurring component or derivative thereof, an aromatic hydroxyl compound-aldehyde resin and an amino resin, wherein the naturally occurring component or derivative thereof is chemically bonded directly or indirectly to the aromatic hydroxyl compound-aldehyde resin (ncPF resin) and optionally the amino resin, and wherein the naturally occurring component or derivative thereof comprises protein.

In an embodiment of the invention is a low formaldehyde emission resin composition for use as a binder of lignocellulosic or cellulosic materials and comprises a condensation product of a naturally occurring component or derivative thereof, an aromatic hydroxyl compound-aldehyde resin and at least 20 wt % of urea based on the total mass of the resin composition, wherein at least 50 wt % of the naturally occurring component or derivative thereof is chemically bound directly or indirectly to the aromatic hydroxyl compound-aldehyde resin (ncPF), and wherein the naturally occurring component or derivative thereof comprises protein.

In another embodiment, the present invention is drawn to a polymerizable resin composition which comprises an aromatic hydroxyl compound, an aldehyde compound and a naturally occurring component or derivative thereof comprising protein, wherein the polymerizable resin composition is prepared in a process comprising combining said naturally occurring component or derivative thereof having a pH≦7 with the aromatic hydroxyl compound and the aldehyde compound, and wherein the protein of the naturally occurring component or derivative thereof is water-based.

In another embodiment, the present invention is drawn to a process of forming a binder for lignocellulosic or cellulosic materials comprising: combining a naturally occurring component or derivative thereof having a pH≦7, an aromatic hydroxyl compound, an aldehyde compound and a nitrogen compound in any order under conditions sufficient to result in the condensation of at least two of the naturally occurring component or derivative thereof, the aromatic hydroxyl compound, the aldehyde compound and the nitrogen compound together, wherein the naturally occurring component or derivative thereof comprises a water-based protein.

Moreover, an embodiment of the present invention is drawn to a lignocellulosic and cellulosic material product comprising said low formaldehyde emission resin composition as a binder.

In addition, an embodiment of the present invention is drawn to a composite board comprising a low formaldehyde emission resin composition which is used as a binder comprising a naturally occurring component or derivative thereof, an aromatic hydroxyl compound, an aldehyde compound, and a nitrogen compound, wherein optionally at least two of the naturally occurring component or derivative thereof, the aromatic hydroxyl compound, the aldehyde compound, and the nitrogen compound have been condensed together to be covalently bound to one another; wherein the composite board has a low formaldehyde emission of less than 0.5 mg/L, preferably of 0.01 to 0.3 mg/L according to JIS A1460, issued March 2001;

wherein when the composite board is a particle board, the particle board meets the mechanical and swelling properties according to standard EN 312, issued October 2003;

wherein when the composite board is a fiberboard, the fiberboard meets the mechanical and swelling properties according to standard EN 622-1 issued June 2003;

wherein when the composite board is a MDF, the MDF meets the mechanical and swelling properties according to standard EN 622-5 issued December 1997; and

wherein when the composite board is an oriented strand board, the oriented strand board meets the mechanical and swelling properties according to standard EN 300, issued September 1997, and

wherein the naturally occurring component or derivative thereof comprises protein.

Furthermore, an embodiment of the present invention is drawn to a wood based panel comprising: layer (X) comprising a low formaldehyde emission resin composition which is used as a binder comprising a naturally occurring component or derivative thereof chemically bound to an aromatic hydroxyl compound-aldehyde resin, and layer (Y) comprising a binder other than said binder in layer (X).

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

### Low Formaldehyde Emission Resin Composition

In an embodiment of the invention, is a low formaldehyde emission resin composition which is used as a binder of lignocellulosic or cellulosic materials and comprises an amino resin and a condensation product of a naturally occurring component or derivative thereof, an aromatic hydroxyl compound-aldehyde resin and optionally said amino resin, wherein the naturally occurring component or derivative thereof is chemically (i.e., ionically, by Van der Waals force and/or covalently, preferably covalently) bonded directly or indirectly to the aromatic hydroxyl compound-aldehyde resin (hereinafter the component of the resin composition which is a naturally occurring component or derivative thereof chemically bonded to an aromatic hydroxyl compound-aldehyde resin is referred to as “ncPF”) and optionally the amino resin (hereinafter the component of the resin composition which is a naturally occurring component or derivative thereof chemically bound to amino resin is referred to as “nc(M)UF”). Said amino resin is present in said low formaldehyde emission resin composition by being mechanically mixed into said composition and/or by being part of the condensation product.

The phrase “naturally occurring component or derivative thereof” is used herein as a single collective term to identify a composition comprising a water-based protein and optionally at least one lignin, organic acid, fatty acid and polyol (for example carbohydrates, starch and sugars). The naturally occurring component or derivative thereof can be vegetable, animal or microbiological origin.

In another embodiment of the invention, is a low formaldehyde emission resin composition which is used as a binder of lignocellulosic or cellulosic materials and comprises a condensation product of a naturally occurring component or derivative thereof, an aromatic hydroxyl compound-aldehyde resin and at least 20 wt % of urea based on the total mass of the resin composition, wherein at least 50 wt % of the naturally occurring component or derivative thereof is chemically bound directly or indirectly to the aromatic hydroxyl compound-aldehyde resin (ncPF), wherein the viscosity of the resin composition is 1 to 500 mPas as measured with a rotational viscosimeter (Physica MCR301) at a shear rate of 1000 s⁻¹ and temperature 25° C. with a spindle PP50 and the amount of solids in the resin composition is 45-75% as measured after heating using standard ASTM D-1490-93, and wherein the naturally occurring component or derivative thereof comprises protein.

It is preferred that the naturally occurring component or derivative thereof is formed in a process of reducing the overall molecular weight in a natural proteinaceous sample of vegetable or animal in a step of extraction and/or a step of performing a bond breaking reaction (such as hydrolysis) to reduce the viscosity of the overall material and thereby form a naturally occurring component or derivative thereof having a water-based protein. Herein, the term “water-based” protein refers to protein(s) which is/are composed of at least one of: i) water soluble protein; ii) a protein which is soluble in a slightly acidic media (e.g., pH of about 4-6.9); and iii) a salt soluble protein. Preferably, the water-based protein is composed of all of the following: i) water soluble proteins; ii) proteins which are soluble in a slightly acidic media (e.g., pH of about 4-6.9); and salt soluble proteins. The naturally occurring component or derivative thereof is essentially free (i.e., may contain trace amounts of up to 1.0 wt % based on the weight of the naturally occurring component or derivative thereof, preferably, less than 0.5 wt %, more preferably less than 0.1 wt %) of proteins which are soluble in ethanol but are not substantially soluble in water, slightly acidic media and salt water media. Gliadins are such ethanol soluble proteins, which form together with glutenins, which are soluble under slightly acidic conditions to give gluten.

The naturally occurring component or derivative thereof can be obtained in a method similar to the method known as corn wet milling. Corn wet milling has been used to separate corn kernels into products such as starch, protein, fiber and oil. Corn wet milling is a two stage process: (a) a steeping process to soften the corn kernel and to facilitate the next step; (b) a wet milling process resulting in purified starch and different co-products such as oil, fiber, and protein. In general, starch recoveries are between 90 to 96%. The remainder of the starch is found in the different co-products. It is this remainder which can be used as the naturally occurring component or derivative thereof.

Other methods of forming the naturally occurring component or derivative thereof are described in WO 2005/074704, which is herein incorporated by reference in its entirety. When the naturally occurring component or derivative thereof is derived from a plant based material, protein and at least one of a carbohydrate, lignin, organic acid, fatty acid and sugar can remain in the material after the extraction procedure and/or bond breaking reaction have been performed. This final composition (the “naturally occurring component or derivative thereof”) will vary depending on type of agriculture species the natural component is sourced from and the way of extraction. When the naturally occurring component is derived from a plant based material, protein and at least one of a carbohydrate, organic acid, fatty acid and sugar can remain in the material after the extraction procedure and/or bond breaking reaction have been performed.

In a most preferred embodiment, the naturally occurring component or derivative thereof is a proteinaceous material isolated from the plant source with water extraction and optionally grinding/milling. Preferably, the isolate has not been exposed to a substantial quantity of chemicals (such as alkali) which hydrolyze the peptide bonds thereby affecting the primary structure of the protein, but the isolate may be denatured, chemically or mechanically, to an extent which affects the secondary and tertiary structure of the protein. In the extraction process, less than 10% of the peptide bonds are broken chemically (irrespective of the percentage of peptide bonds broken by mechanical means) in forming the isolate. Preferably, less than 3% and more preferably, less than 0.1% of the peptide bonds are broken chemically (irrespective of the percentage of peptide bonds broken by mechanical means) in forming the isolate. For example, the method of derivatizing wheat comprises a step of separation based on solubility of the components in water (pure water, salt water, or slightly acidic water) so as to separate the high molecular weight proteins in gluten (such as gliadins and possibly glutenins) and high molecular weight carbohydrates (the insoluble portion) from the lower molecular weight proteins such as albumin and the low molecular weight carbohydrates (soluble portion).

This naturally occurring component or derivative thereof has a solid content concentration of 40-60 wt %, preferably 44-56 wt % as measured by heating the volatiles off in an oven until the weight stabilizes and calculating the weight of the final composition as a percent of the weight of the sample prior to heating. The viscosity of the naturally occurring component or derivative thereof is 100-3000 mPas, preferably 100-300 mPas. In the preferred embodiment of the invention the viscosity is less than 300 mPas. The viscosity measurements used herein are measured with a rotational viscosimeter (Physica MCR301) at a shear rate of 1000 s⁻¹ and temperature 25° C. with a spindle PP50. The amount of protein in the naturally occurring component or derivative thereof is preferably 1-20 wt % solid based on the total weight of solids, more preferably 5-20 wt %, and the amount of carbohydrates is preferably 20-60 wt % based on the total weight of solids, more preferably 30-55 wt %. The pH of the natural component is <7, preferably less than 6 and more preferably less than 4.5.

Preferably, the naturally occurring component or derivative thereof is formed from at least one selected from the group consisting of wheat, corn, rapeseed (canola), soy, rice, etc or a derivative thereof. More preferably, the naturally occurring component or derivative thereof is formed from wheat and/or corn or a derivative thereof. Most preferably, the naturally occurring component or derivative thereof is not formed from soy or casein.

The aromatic hydroxyl compound-aldehyde component includes curable aldehyde condensation resins such as, for example, phenol-aldehyde resins, resorcinol-aldehyde resins, and the like. Aromatic hydroxyl compounds (sometimes referred to herein using the identifier “P”) which can be used to prepare these condensation-type resins comprise phenol and various modified phenols including amino phenol, the ortho, meta and para cresols, cresylic acid, xylenol, resorcinol, catechol, hydrochinon, bisphenol A, quinol (hydroquinone), pyrogallol (pyrogallic acid), phloroglucinol, or combinations thereof, and the like. Preferably, the aromatic hydroxyl compound is resorcinol, hydrochinon, phenol or bisphenol A. More preferably, the aromatic hydroxyl compound is phenol. These compounds or combinations thereof can be reacted with the various aldehydes (sometimes referred to herein using the identifier “F”), as a class, preferably those having from 1 to about 10 carbon atoms in aliphatic or cycloaliphatic or aromatic or mixed form, to produce the condensation-type resins useful in the invention. Such aldehyde compounds include, for example, formaldehyde, glyoxal, glutaraldehyde, acetaldehyde, propionaldehyde, crotonaldehyde, benzaldehyde, furfuraldehyde, and the like. Formaldehyde is presently preferred.

The amino resins are curable aldehyde condensation resins which include, for example, urea-aldehyde resins (urea is sometimes referred to herein using the identifier “U”), aniline-aldehyde resins, melamine-aldehyde resins (melamine is sometimes referred to herein using the identifier “M”), mixtures of two of these resins, melamine-urea cocondensation-aldehyde resins, and the like. The aldehyde compounds for use in the preparation of the amino resins include those useful in preparing the ncPF resins as described in the previous paragraph. The nitrogen compounds (e.g., amines, amides and triazines) which can be used to prepare the amino resins comprise ammonia, urea, ethyleneurea, thiourea, guanidine, methylurea, acetylurea, cyanamide, dicyanodiamide, biuret, semi-carbazide, melamine, monophenylmelamine, ammeline, thioammeline, ammelide, formoguanamine, acetoguanamine, stearoguanamine, and the like. Preferably, the amino resin is a urea formaldehyde resin, melamine formaldehyde resin or a melamine-urea-formaldehyde resin which latter can be produced by mixing two out of the group of urea formaldehyde resin, melamine formaldehyde resin and melamine-urea-formaldehyde resin or by cocondensation of urea and melamine with formaldehyde.

In an embodiment, the binder resin composition comprises the naturally occurring component or derivative thereof which is chemically (i.e., ionically, by Van der Waals force and/or covalently, preferably covalently) bound directly or indirectly to the backbone of the aromatic hydroxyl compound-aldehyde resin (ncPF) and/or the backbone of the amino resin (nc(M)UF). In addition, the naturally occurring component or derivative thereof can act as a crosslinker between the aromatic hydroxyl compound-aldehyde resin and/or the amino resin. Preferably, it is a protein in the naturally occurring component or derivative thereof, which is bound directly or indirectly to the backbone of the aromatic hydroxyl compound-aldehyde component.

The viscosity of the ncPF is 20-1000 mPas, preferably from 20-300 mPas. The amount of solids in the ncPF is 41-80%, preferably 45-60%. The molar ratio of the ncPF is 1.0:0.1 P/F to 1.0:4.0 P/F. The amount of the naturally occurring component or derivative thereof in the ncPF is 1-60 wt %, preferably 1-50 wt % based on the total weight of ncPF resin.

The molar ratio of F to amino groups in the nc(M)UF is 0.3-1.0:1.0, Preferably the molar ratio is 0.3-0.7:1.0, and more preferably 0.35-0.6:1.0. The solids content of the nc(M)UF is 50 to 80%, preferably 50-70% based on total solids. The viscosity of the nc(M)UF is 10-1000 mPas, preferably 50-700 mPas.

Depending upon the manner in which the components for preparing the amino resins are combined with the components for preparing the ncPF resins, it is possible to form hybrid binders such as an ncPF resin that comprise nitrogen compounds incorporated into the backbone of the resin or in side groups or in side chains or any other form which is chemically linked.

The ratio of the natural component or derivative thereof to amino (or amide groups) in the nc(M)UF resin based on the dry weight of each component is 99.9:0.1 to 50:50, preferably 99:01:70:30.

In the embodiment which includes both nc(M)UF and ncPF, the dry weight ratio of nc(M)UF:ncPF is 99.8:0.2 to 90:10.

The ratio of amino resin to ncPF in the resin composition is 99:1 to 50:50 based on the dry weight of each component. Preferably, the ratio is 90:10 to 60:40. More preferably, 85:15 to 70:30.

In an embodiment of the invention, the resin composition comprises ncPF resin and at least 20 wt % urea based on the total mass of the resin composition, preferably 20-50 wt % urea.

In an embodiment of the invention, the molar ratio of amino (or amide groups)/aldehyde in the amino resin composition is 1:0.3-1.0. Preferably, the molar ratio is 1:0.3 to 1:0.7. More preferably, the molar ratio is 1:0.35 to 1:0.6.

In an embodiment of the invention, the molar ratio of nitrogen groups to aromatic hydroxyl groups in the binder resin composition is 1:0-0.25. Preferably, the molar ratio is 1:0 to 1:0.15. More preferably, the molar ratio is 1:0.01 to 1:0.1.

In an embodiment of the invention, the molar ratio of hydroxyl groups (of the aromatic hydroxyl compound) to aldehyde in the resin composition is. Preferably, the molar ratio is 1:0.1 to 1:400. More preferably, the molar ratio is 1:0.9 to 1:80.

In an embodiment of the invention, the solid content of the resin composition is 50-75 wt % based on the total resin composition (as measured after heating using standard ASTM D-1490-93). Preferably, the solid content is 45 to 75 wt %. More preferably, the solid content is 60 to 70 wt %.

In an embodiment of the invention, the amino resin comprises melamine in a concentration of 1-65 wt % based on total weight of solids in the resin composition.

The resin composition of the present invention may include components typically used in the art, such as additives, extenders, hardeners, flexibilizers, polyurethanes (such as MDI), etc.

The resin composition of the present invention may be stored in a concentrated form which can then be diluted prior to application to the lignocellulosic or cellulosic material. This is advantageous in view of the reduction in storage costs. The viscosity of the concentrated composition is 10 to 3500 mPas (for storage). Preferably, the concentration of solids is 45 to 75%. More preferably, the concentration of solids is 60 to 70%. Whereas, the viscosity of dilute composition is 1 to 2000 mPas (at time of application). Preferably, the viscosity is 1 to 700 mPas. More preferably, 1 to 500 mPas. The pH of the resin composition is preferably moderate, i.e., 7-10.

This resin composition of the present invention has very low formaldehyde emissions when in its final form, and as such is very advantageous for use as a binder of lignocellulosic or cellulosic materials.

### Polymerizable Resin Composition

In an embodiment, the present invention is drawn to a polymerizable resin composition which comprises an aromatic hydroxyl compound an aldehyde compound and a naturally occurring component or derivative thereof comprising protein, wherein the polymerizable resin composition is prepared in a process comprising combining said naturally occurring component or derivative thereof having a pH≦7 with the aromatic hydroxyl compound and aldehyde compound, wherein the protein of the naturally occurring component or derivative thereof is water-based.

In another embodiment, the present invention is drawn to a polymerizable resin composition which comprises an aromatic hydroxyl compound-aldehyde resin and a naturally occurring component or derivative thereof comprising protein, wherein the polymerizable resin composition is prepared in a process comprising combining said naturally occurring component or derivative thereof having a pH≦7 with the aromatic hydroxyl compound-aldehyde resin, wherein the protein of the naturally occurring component or derivative thereof is water-based.

In yet another embodiment, the present invention is drawn to a polymerizable resin composition which comprises an aromatic hydroxyl compound-aldehyde resin and a naturally occurring component or derivative thereof comprising protein, wherein the polymerizable resin composition is prepared in a process comprising condensing said naturally occurring component or derivative thereof having a pH≦7 with the aromatic hydroxyl compound-aldehyde resin, wherein the protein of the naturally occurring component or derivative thereof is water-based, and wherein the water-based protein is chemically bonded directly or indirectly to the aromatic hydroxyl compound-aldehyde resin.

### Methods of Forming the Low Formaldehyde Emission Resin Composition

The binder of lignocellulosic or cellulosic materials of the present invention can be made in a variety of methods. For example, the binder is made in a process comprising combining the naturally occurring component or derivative thereof, the aromatic hydroxyl compound, the aldehyde compound and the nitrogen compound in any order in an aqueous media (i.e., aqueous solution wherein all the constituents are not necessarily dissolved) under conditions sufficient to result in the condensation of at least two of the natural component or derivative thereof, the aromatic hydroxyl compound, the aldehyde compound and the nitrogen compound together.

The description of the naturally occurring component or derivative thereof and the process for preparing the same are given above in the section titled “Low Formaldehyde Emission Resin Composition.”

In an embodiment, the method of forming the binder resin composition includes a step of forming a PF resin having a weight average molecular weight of at least 200 g/mole, preferably up to 12,000 g/mole, more preferably 200-12,000 g/mole and a step of condensing said PF resin with, in any order, at least one of a natural component or derivative thereof, an aromatic hydroxyl compound, an aldehyde compound and an amino compound.

In an embodiment, the method includes a step of forming an ncPF resin by combining, in any order, a natural component or derivative thereof with an aromatic hydroxyl compound and an aldehyde compound.

In an embodiment, the method includes a step of forming an nc(M)UF resin by combining, in any order, a natural component or derivative thereof with a nitrogen compound and an aldehyde compound.

In view of the fact that urea has a tendency to denature proteins, it is preferred to use methods which minimize this affect. In an embodiment, the method includes a step of condensing an aldehyde compound with a nitrogen compound to form an amino resin in one batch, a step of condensing a natural component or derivative thereof with an aromatic hydroxyl compound and an aldehyde compound to form a ncPF resin in a second batch and a step of blending the two batches.

In a preferred embodiment, at least one of the natural component or derivative thereof, aromatic hydroxyl compound and nitrogen is methylolated prior to the condensing step as exemplified in the following figure:

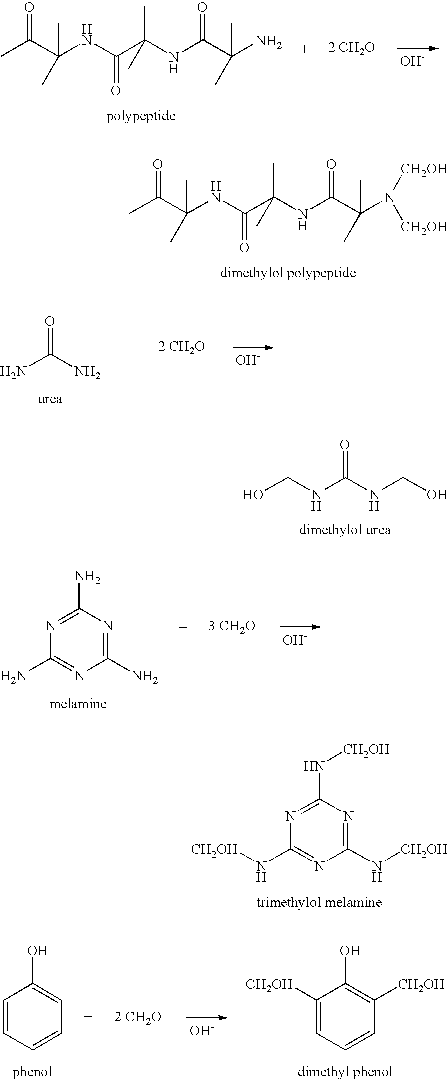

The step of condensing the aromatic hydroxyl compound and the aldehyde compound is preferably performed in an aqueous media under neutral to alkaline conditions, i.e., pH of 7 to 13. If necessary, the pH can be controlled with organic and/or inorganic base.

The step of condensing the nitrogen compound and the aldehyde compound is preferably performed in an aqueous media under slightly alkaline to acidic conditions, i.e., pH of 9 to 3. If necessary, the pH can be controlled with organic and/or inorganic acids, salts or combination of acids and salts.

In the inventive method, the acid is not specifically limited in amount (other than being present in a catalytic amount) or in type, although it is preferably selected from the group consisting of hydrochloric acid, sulfuric acid, phosphoric acid, formic acid, acetic acid, citric acid, propionic oxalic acid, p-toluenesulfonic acid, benzoic acid, phthalic acid and maleic acid.

Likewise, the base is not specifically limited in amount (other than being present in a catalytic amount) or in type, although it is preferably selected from the group consisting of a nitrogenous base such as an ethanolamine (e.g., dimethylethanolamine or diethanolamine), sodium hydroxide, potassium hydroxide, calcium hydroxide, tin compounds (dibutyltin dilaurate, dibutyltin dioctoate and dibutyltin diacetate) and the like. The use of a nitrogenous base is especially preferred because it gives less ash content, does not dilute the product (alkalis have to be used in concentrations not higher than 1N), and overall the final product has better mechanical properties.

In an embodiment, the method includes an initial step of forming an aqueous media containing ncPF by condensing the aromatic hydroxyl compound, a first aldehyde compound and the natural component or derivative thereof, and a second step of forming the amino resin in situ by adding a second aldehyde compound (wherein the second and first aldehyde compounds may be the same or different) and nitrogen compound to the solution. The reaction between the nitrogen compound and the aldehyde compound may be exothermic and the reaction temperature is preferably maintained to less than 100° C. The pH is then adjusted with an acid to be neutral to slightly acidic (preferably the pH is 4-7). The solution is condensed at 80-100° C. to a viscosity of 50-3000 mPas, preferably 50-800 mPas measured at 25° C. Once the desired viscosity has been reached, the solution is cooled to room temperature. It is preferred to have the amount of solids in the final solution at 50-75 wt %, preferably 60-68 wt %, based on the total weight of the solution. If the amount of solids in the solution has not reached 50 wt % at this point in the process, the solids concentration can be increased by adding more ncPF, nitrogen compound, aldehyde compound and/or amino resin in subsequent step(s) to the solution.

It is possible to add additional solvent(s) to the aqueous media to help dissolve the reactants, so long as the additional solvent(s) do not react with the reactants.

### Products Comprising the Low Formaldehyde Emission Resin Composition

The present invention is drawn to lignocellulosic and cellulosic material products comprising a binder comprising at least one of resin compositions (A) and (B):

wherein resin composition (A) comprises a condensation product of a naturally occurring component or derivative thereof, an aromatic hydroxyl compound-aldehyde resin,

wherein said low formaldehyde emission resin composition further comprises an amino resin as part of said condensation product and/or as a component mixed therein,

wherein the naturally occurring component or derivative thereof is chemically bonded directly or indirectly to the aromatic hydroxyl compound-aldehyde resin (ncPF resin) and optionally the amino resin,

wherein the viscosity of the resin composition is 1 to 500 mPas as measured with a rotational viscosimeter at a shear rate of 1000 s⁻¹ and temperature 25° C. and the amount of solids in the resin composition is 45-75% as measured after heating using standard ASTM D-1490-93, and

wherein the naturally occurring component or derivative thereof comprises protein;

wherein resin composition (B) comprises a condensation product of a naturally occurring component or derivative thereof, an aromatic hydroxyl compound-aldehyde resin and at least 20 wt % of urea based on the total mass of the resin composition,

wherein at least 50 wt % of the naturally occurring component or derivative thereof is chemically bonded directly or indirectly to the aromatic hydroxyl compound-aldehyde resin (ncPF),

wherein the viscosity of the resin composition is 1 to 500 mPas as measured with a rotational viscosimeter at a shear rate of 1000 s⁻¹ and temperature 25° C. and the amount of solids in the resin composition is 45-75% as measured after heating using standard ASTM D-1490-93, and

wherein the naturally occurring component or derivative thereof comprises protein.

The lignocellulosic or cellulosic material is a multilayer or single layer substrate. The multilayer or single layer substrate includes a composite board (preferably particle board, oriented strand board or fiberboard), plywood, parquet, LVL, lamination of wood, board on frame, and impregnation of paper. The advantage of the inventive lignocellulosic or cellulosic material products comprising the resin composition for binder includes both high strength and a low formaldehyde emission property. The preparation methods of these lignocellulosic or cellulosic materials with known binders is described in: A) M. Dunky and P. Niemz, “Holzwerkstoffe and Leime” (Wood based panels and resin adhesives), Springer, 2002; B) European Commission Directorate-General for research, COST Action E13 Wood adhesion and glued products Working group 2, Glued wood products State-of-the-art report Volume 2 Edited by Carl-Johan Johanson, Tony Pizzi and Marc Van Leemput, Second Edition, August 2002, Chapter 3.1; and C) Hans-Joachim Deppe and Kurt Ernst, “MDF-Mitteldichte Faserplatten” DRW-Verlag, 1996, ISBN 3-87181-329-X, all of which are herein incorporated by reference in their entirety.

The main target was the development of a resin system in combination with the suitable production technology which allows the production of such boards without or with only neglectable efficiency loss compared to standard boards, usually produced in Europe by means of straight urea formaldehyde resin.

The subsequent formaldehyde emission out of wood based panels bonded with formaldehyde based adhesive resins is evoked by residual formaldehyde present in the boards and by the hydrolysis of weakly bonded formaldehyde in the hardened resin. Amino resin bonded boards show a formaldehyde emission mainly determined by the molar ratio of the resin and the resin mix. The lower the molar ratio of an amino resin, the lower usually is the subsequent formaldehyde emission out of the finished board. The subsequent formaldehyde emission has been described extensively in the technical/chemical literature, like M. Dunky and P. Niemz, as cited supra to just mention one example.

The subsequent formaldehyde emission can be described as the amount of formaldehyde actually emitted, e.g. as concentration of formaldehyde in a climate chamber, or as the emittable potential of formaldehyde in the board. There are different test methods which have been created, for how to characterize (i) the formaldehyde content as potential emittable formaldehyde, and (ii) the effective emission out of the boards. This is important to be distinguished, because both approaches consider the various sources of formaldehyde in a board in a different way. The so-called perforator test measures the total content of free (emittable) formaldehyde in the board, not considering if at all and if yes with which speed (=amount per time, based on a certain surface area) this emission will take place. Considering the fact that (neglecting in a first view the emission behaviour out of the edges which based on the same area is distinctly higher, but the portion of edges usually is rather small) the emission mainly takes place via the surface layer of the board. This means that the emittable formaldehyde in the surface layer of three layer boards (in the outer layers of a single layer board) must be seen different to the emittable formaldehyde in the core/inner layer.

For amino resins the molar ratio formaldehyde/urea for pure urea formaldehyde resins or the formaldehyde/(NH₂)₂ for amino resins also containing other raw materials with NH₂ groups like melamine is one of the most significant parameters concerning the content of emittable formaldehyde. The subsequent formaldehyde emission is more or less strictly correlated to this molar ratio: i.e., the lower this molar ratio, the lower is the formaldehyde emission.

In the present invention, the ratio of aldehyde compound to nitrogen compounds is controlled to provide the ideal balance in properties. Decreasing the molar ratios formaldehyde/urea or formaldehyde/(NH₂)₂ of an amino resin and hence decreasing the content of available formaldehyde in the resin means:

a) for the adhesive resin:
a decrease of the reactivity of the resin due to the lower content of available formaldehyde;
a decrease of the degree of cross-linking in the cured network; and
an increase of the susceptibility for hydrolysis,
   b) for the produced boards:
a decrease of the formaldehyde emission during the production of the wood based panels;
a decrease of the subsequent formaldehyde emission;
a decrease of the mechanical properties;
a decrease of the degree of hardening (cross-linking); and
an increase of the thickness swelling and the water absorption of the board.

For the so-called post treatment of boards, several methods exist, like an ammonia treatment or a treatment with urea and ammonia producing compounds, but are used today only in few cases. A comprehensive summary of such methods was given by G. E. Myers: Effects of post-manufacture board treatments on formaldehyde emission: a literature review (1960-1984), Forest Products Journal 36 (1986) 6, 41-51. Also coating and sealing of the board surface reduces the subsequent formaldehyde emission. It is preferred to seal open edges of boards in furniture in order to reduce the subsequent formaldehyde emission.

The main drawback of all known production procedures of boards with low emission is a distinct increase in production costs due to several factors. Compared to standard urea formaldehyde resins the adhesive prices (always indicated in figures based on solids) are 30 to 70% higher for amino resins depending on the necessary content of melamine in the adhesive resin; for aromatic hydroxyl compound-aldehyde resins approximately the double price is given, whereas for isocyanate based adhesives the price can be 5 to 6 times higher.

The estimated increase in adhesive consumption (which itself is expressed as % adhesive solids/dry furnish) is plus 10-20% for amino resins and plus 20% for aromatic hydroxyl compound-aldehyde resins, all numbers again compared to standard boards with urea formaldehyde resins. The adhesive consumption for isocyanate is not directly comparable with urea formaldehyde resins.

The reduction in press speed compared to standard boards with urea formaldehyde resins expressed as loss in capacity is 10-20% for amino resins, 20-30% for aromatic hydroxyl compound-aldehyde resins and up to 50% for isocyanate based adhesives.

It is not surprising that simply combining phenol formaldehyde resins with urea formaldehyde resins has not been adopted by the industry, when one takes into consideration that urea formaldehyde resins cure at a low pH while phenol formaldehyde resins cure at a high pH. However, the present inventors have ingeniously found a process that makes this combination possible. Furthermore, with the addition of a natural component to the phenol formaldehyde resins and the urea formaldehyde resins, the present inventors have surprisingly found that the resulting binder has high strength properties at higher production efficiency (compared to pure phenol formaldehyde resins) and importantly, has reduced formaldehyde emissions. In addition, there would be a great benefit in using the natural component in these binders, since the natural component is available from renewable resources.

The present invention is drawn to a composite board comprising a low formaldehyde emission resin composition which is used as a binder comprising a naturally occurring component or derivative thereof, an aromatic hydroxyl compound, an aldehyde compound, and a nitrogen compound, wherein optionally at least two of the naturally occurring component or derivative thereof, the aromatic hydroxyl compound, the aldehyde compound, and the nitrogen compound have been condensed together to be covalently bound to one another;

wherein the composite board has a low formaldehyde emission of less than 0.5 mg/L, preferably of 0.01 to 0.3 mg/L according to JIS A1460, issued March 2001;

wherein when the composite board is a particle board, the particle board meets the mechanical and swelling properties according to standard EN 312, issued October 2003;

wherein when the composite board is a fiberboard, the fiberboard meets the mechanical and swelling properties according to standard EN 622-1 issued June 2003;

wherein when the composite board is a MDF, the MDF meets the mechanical and swelling properties according to standard EN 622-5 issued December 1997; and

wherein when the composite board is an oriented strand board, the oriented strand board meets the mechanical and swelling properties according to standard EN 300, issued September 1997.

It is preferred to run the tests for mechanical and swelling properties at approximately 5-20% solid resin loading, preferably 10% solid resin loading on a solid dry wood substrate and at a press time between 3.5-18 s/mm.

In an embodiment of the invention, the composite board further comprises a layer containing a binder composition that does not contain the natural component or derivative thereof.

In an embodiment of the invention, the composite board further comprises at least one layer of PMDI.

In an embodiment of the invention, the resin composition (A) and/or resin composition (B) is applied to the composite board as a surface spray or top spray.

In an embodiment of the invention, is a process of coloring the composite board comprising the resin composition (A) and/or resin composition (B) by electrocoating at least a surface of the composite board with a powder paint. At the point of electrocoating, the binder resin of the present invention typically has a salt content high enough to conduct electrocoating. The amount of salts can be modified to optimize the electrocoating.

The present invention is also drawn to plywood, parquet, LVL, wood lamination, board on frame, or paper comprising at least one of resin compositions (A) and (B) as described above.

In an embodiment of the invention, the plywood, parquet, LVL, wood lamination, or board on frame further comprises a layer containing a binder composition that does not contain the natural component or derivative thereof.

In an embodiment of the invention, the plywood, parquet, LVL, wood lamination, or board on frame further comprises at least one layer of PMDI.

In an embodiment of the invention, the resin composition (A) and/or resin composition (B) is applied to the plywood, parquet, LVL, wood lamination, or board on frame as a surface treater.

In an embodiment of the invention, is a process of coloring the plywood, parquet, LVL, wood lamination, or board on frame comprising the resin composition (A) and/or resin composition (B) by electrocoating at least a surface of the plywood, parquet, LVL, wood lamination, or board on frame with a powder paint.

In an embodiment of the invention is a wood based panel comprising: layer (X) comprising a low formaldehyde emission resin composition which is used as a binder comprising a naturally occurring component or derivative thereof chemically bound to an aromatic hydroxyl compound-aldehyde resin, and layer (Y) comprising a binder other than said binder in layer (X). It is preferred that the binder in said layer (Y) comprises an amino resin. It is more preferred that the layer (X) is a face layer of the wood based panel and layer (Y) is a core layer of the wood based panel.

### EXAMPLES

### Example 1

### Binder Resin Composition Containing ncPF, Urea and Formaldehyde)

First, ncPF is prepared. A water-based derivative of wheat (having a concentration (solid content) of 50%, pH of 4.3 and viscosity of 103 mPas, with approximately 7.6% protein and approximately 47% sugars, based on the solids content) is condensed with a pre-condensed phenol-formaldehyde resin under alkaline conditions to give a viscosity of 150 mPas, pH of 9.5 and a solids content of 59% to give ncPF.

Second, the binder resin composition is prepared. 428.7 g Formaldehyde at (51%) is added 8.2 g ncPF at 50% solids. After 10 minutes, 121.5 g urea is added. The reaction exothermically increases the temperature to 80° C. 106.9 g of urea is then added. The reaction exothermically increases the temperature to 97° C. After 10-30 minutes, the batch is cooled down to 92° C. The pH is adjusted with organic acid to 5.4. The batch is condensed at 92° C. At the desired viscosity of 304 mPas, 368.0 g of ncPF and 30.7 g formaldehyde followed by 47.4 g of urea are added to the batch, which is then condensed to a viscosity of over 350 mPas. At the target viscosity of 275 mPas, 125.3 g urea is added and the batch is cooled down to 52° C. Distillation is performed to reach a solids content of 64%. To bring the pH to over 7.5, 15.8 g ncPF is added. The batch is cooled down to 25° C.

Yellowish brown binder has a viscosity of (330) mPas at 25° C. and pH>8.0. (8.8).

The binder maintains a stable viscosity and pH properties for several weeks.

### Example 2

### Application of the Hybrid Binder (as Co-Condensate) in Preparation of a Single Layer of a Composite Board

The binder of Example 1 is mixed with 0.5%-1% solid hardener to solid resin. The glue mix is sprayed on the fibers at a loading of 10% binder to dry wood.

When the composite board is an MDF board, the MDF board is produced at 6.2 s/mm.

### Example 3

### Application of the Hybrid Binder (as Co-Condensate) in Preparation of a Multi Layer Composite Board

In the following table, a urea formaldehyde resin is used as the amino resin for the adhesive binder. The adhesive binder is applied to a particle board at the loadings and press times given in the table.

| | | | Loading | Specific | Perforator |
|---|---|---|---|---|---|
| | | | (solid resin % | press time | value |
| | | Adhesive | on solid | (laboratory | according to |
| Board | | binder | wood) | press) | EN 120 |
| 1 | Face | Amino | 10 | 7.5 | 3.3 |
| | Core | Amino | 10 | | |
| 2 | Face | Binder of | 10 | 7.5 | <2.0 |
| | | Example 1 | | | |
| | Core | Amino | 10 | | |

The entries for Boards 1 and 2, as described in the above-table are theoretical values. These values show that it is expected to have reduced formaldehyde emissions when the hybrid binder of the present invention is used in the face of the board.

### Example 4

### Application of the Hybrid Binder (as a Blend) in Preparation of Composite Board (CB) as a Single Layer

Under the same running conditions the board properties of the MDF boards made with differing adhesives are compared with boards made from a sole component adhesive.

Wood fibers are resinated with three different adhesives as follows.

1) A urea formaldehyde resin is used as the amino resin at a concentration of 66%, a viscosity of 450 mPas, a ratio of F/NH₂ of 0.475, and a pH of 9.5. The amino resin at 10% solids to solid wood is sprayed on the fibers together with 0.5% Ammonium salt as a hardener;

2) The ncPF resin described in Example 1 is used at a concentration of 57.5%, a viscosity of 150 mPas, and a ratio of F/P of 2.6. The ncPF resin at 10% solids to solid wood is sprayed on the fibers.

3) The urea formaldehyde resin of adhesive 1) is mixed with the ncPF described in Example 1 along with a hardener immediately prior to application to the fiber. 7.5% solids to solid wood of the amino resin and 2.5% solids to solid wood of ncPF resin are either mixed together with 0.5% solids Ammonium salt to solid resin, or all three parts are sprayed separately onto the wood fibers.

12 mm MDF boards at density 750 kg/m³ are made at press platen temperature of 250° C. and pressure of 65 bar. Pressing time is 11 s/mm for runs 1 and 3 and 13 s/mm for run 2 (ncPF). The results are shown in the following table.

| | | | | | Internal Bond | |
|---|---|---|---|---|---|---|
| | | | | | Strength (IB) | |
| | Loading (solid | | Perforator value | Desiccator value | value according | Thickness Swelling |
| | resin % on solid | Specific press time | according to EN | according to JIS | to | value according to |
| Adhesive | wood) | (laboratory press) | 120 | A1460 | EN 319 | EN 317 |
| Amino | 10 | 11 | 6.3 | 0.66 | 1.08 | 13.8 |
| ncPF | 10 | 13* | 0.5 | 0.023 | 0.77 | 9.1 |
| Amino/ncPF | 7.5/2.5 | 11 | 3.6 | 0.33 | 1.23 | 10.8 |

*At specific press time (laboratory press) of 11 it was not possible to produce boards with this adhesive.

This table shows that the MDF boards with identical loading of resin solids based on the weight of the wood, have differing strength properties, press times, and formaldehyde emissions. The amino resin compared to the phenol formaldehyde resin in much the same way as is known in the art, i.e., the amino resin has better strength properties, reduced press times, but at the expense of high formaldehyde emissions and high swelling when compared to the phenol aldehyde resin. However, by replacing 25% of amino resin by the ncPF with the amino resin, there is a reduction of formaldehyde emissions of 50% when compared to the pure amino resin, while increasing the strength (IB value) approximately 14%. In addition, there is a reduction in the swelling of the MDF board with the hybrid binder when compared to the amino resin binder.

### Example 5

### Application of the Hybrid Binder (as a Blend) in Preparation of CB as a Single Layer

Under the same running conditions the board properties of the MDF boards made with differing adhesives are compared with boards made from a sole component adhesive.

1) A urea formaldehyde resin is used as the amino resin at a concentration of 66.5%, a viscosity of 439 mPas, a ratio of F/NH₂ of 0.415, and a pH of 9.8. The amino resin at 10% solids to solid wood is sprayed on the fibers together with 0.5% ammonium salt as a hardener;

2) The ncPF resin described in Example 1 is used at a concentration of 57.5%, a viscosity of 150 mPas, and a ratio of F/P of 2.6. The ncPF resin at 10% solids to solid wood is sprayed on the fibers.

3) The urea formaldehyde resin of adhesive 1) is mixed with the ncPF described in Example 1 along with a hardener immediately prior to application to the fiber. 7.5% solids to solid wood of the amino resin and 2.5% solids to solid wood of ncPF resin are either mixed together with 0.5% solids ammonium salt to solid resin, or all three parts are sprayed separately onto the wood fibers.

12 mm MDF boards at density 750 kg/m³ are made at press platen temperature of 250° C. and pressure of 65 kg/cm² bar. The pressing times and expected results are shown in the following table.

| | Loading (solid | | Perforator value | Desiccator value | IB value |
|---|---|---|---|---|---|
| | resin % on solid | Specific press time | according to EN | according to JIS | according to |
| Adhesive | wood) | (laboratory press) | 120 | A1460 | EN 319 |
| Amino | 10 | 9 | 9.2 | 0.890 | 1.08 |
| ncPF | 10 | 13* | 0.5 | 0.023 | 0.77 |
| Amino/ncPF | 7.5/2.5 | 9 | 4.9 | 0.439 | 1.13 |

*At specific press time (laboratory press) of 9 it was not possible to produce boards with this adhesive

This table shows that the MDF boards with identical loading of resin solids based on the weight of the wood, have differing strength properties, press times, and formaldehyde emissions. The amino resin compared to the phenol aldehyde type resin in much the same way as is known in the art, i.e., the amino resin has better strength properties, reduced press times, but at the expense of high formaldehyde emissions when compared to the phenol aldehyde type resin. However, upon including 25% of the ncPF with the amino resin, there is a reduction of formaldehyde emissions of ˜50% when compared to the pure amino resin, while increasing the strength (IB value) approximately 5%.

### Example 6

### Production of MDF Boards by Using Hybrid Amino/ncPF as Adhesive

1) A urea formaldehyde resin is used as the amino resin at a concentration of 66%, a viscosity of 150 mPas, a ratio of F/NH₂ of 0.40, and a pH of 9.0. The amino resin at 10% solids to solid wood is sprayed on the fibers together with 0.5% ammonium salt as a hardener;

2) The urea formaldehyde resin of adhesive 1) is mixed with the ncPF of Example 1 along with a hardener immediately prior to application to the fiber. 7.5% solids to solid wood of the amino resin and 2.5% solids to solid wood of ncPF resin are either mixed together with 0.5% solids ammonium salt to solid resin, or all three parts are sprayed separately onto the wood fibers.

| | | | | | Thickness |
|---|---|---|---|---|---|
| | | | | | Swelling |
| | | Perforator value | Desiccator value | IB value | value |
| | Specific press time | according to EN | according to JIS | according to | according to |
| Adhesive | (laboratory press) | 120 | A1460 | EN 319 | EN 317 |
| Amino | 11 | 3.5 | 0.33 | 1.16 | 10.7 |
| Amino/ncPF | 11 | 2.4 | 0.24 | 1.12 | 9.7 |

The data in the above-table compares an amino resin with essentially the same resin except that 25% of the amino resin is replaced with ncPF. The resins are applied under same process parameters. The hybrid amino/ncPF system is expected to produce boards resulting in significantly reduced formaldehyde emissions while maintaining the mechanical properties.

### Example 7

### Application of the Hybrid Binder (as a Blend) in Preparation of a Multilayer Board, which is a Particle Board

1) A urea formaldehyde resin is used as the amino resin at a concentration of 68.3%, a viscosity of 200 mPas, a ratio of F/NH₂ of 0.465, and a pH of 9.0. The amino resin at 10% solids to solid wood is sprayed on the chips (particles) together with 0.5% ammonium salt as a hardener;

2) The urea formaldehyde resin of adhesive 1) is mixed with an ncPF having a concentration of 49/8%, a viscosity of 154 mPas and F/P of 2.8 along with a hardener immediately prior to application to the chips. 7.5% solids to solid wood of the amino resin and 2.5% solids to solid wood of ncPF resin are either mixed together with 0.5% solids ammonium salt to solid resin, or all three parts are sprayed separately onto the chips.

A 14 mm 3-layer particle board is produced using the amino resin as an adhesive in the core layer and the hybrid amino/ncPF resin in the face layer.

| | | | | | | | Thickness |
|---|---|---|---|---|---|---|---|
| | | | Loading | Specific | | IB value | Swelling |
| | | | (solid resin % | press time | Perforator value | according | value |
| | | | on solid | (laboratory | according to | to | according to |
| Board | | Adhesive | wood) | press) | EN 120 | EN 319 | EN 317 |
| 1 | Face | Amino | 10 | 7.5 | 4.6 | 0.43 | 17 |
| | Core | Amino | 10 | | | | |
| 2 | Face | Amino/ncPF | 7.5/2.5 | 7.5 | 3.6 | 0.45 | 12.3 |
| | Core | Amino | 10 | | | | |

This table shows that the particle boards with identical loading of resin solids based on the weight of the wood, had differing strength properties, swelling values and formaldehyde emissions for particle boards prepared under the same press times, when the face of the particle board is prepared with the inventive hybrid binder versus a particle board made with a face comprising an amino resin. The particle board made with the hybrid binder in the face of the board had better strength properties, reduced swelling, and lower formaldehyde emissions when compared to the particle boards made with an amino resin binder in the face of the board.

### Example 8

### Application of the Two System Adhesive in a Three Layer Particle Board Having a Face/Core/Face Structure)

Wood particles were resinated with two different adhesives as follows.

1) A urea formaldehyde resin is used as the amino resin at a concentration of 68.3%, a viscosity of 200 mPas, a ratio of F/NH₂ of 0.465, and a pH of 9.0.

2) The ncPF resin described in Example 1 is used at a concentration of 49.8%, a viscosity of 154 mPas, and a ratio of F/P of 2.8. The ncPF resin at 10% solids to solid wood is sprayed on the fibers.

The core was prepared by mixing the amino resin with 3% (solid/solid) hardener (ammonium salt/formic acid) and spraying the mix on wood chips.

The face was prepared by mixing either the amino resin or the ncPF with a hardener and spraying the mix on the wood chips (particles).

14 mm 3-layer particle boards were produced using an amino resin as adhesive in the core layer and ncPF resin in the face layer, according to this patent application. The results are shown in the following table.

| | | | Loading | Specific | Perforator |
|---|---|---|---|---|---|
| | | | (solid resin % | press time | value |
| | | | on solid | (laboratory | according to |
| Board | | Adhesive | wood) | press) | EN 120 |
| 1 | Both | Amino | 10 | 7.5 | 3.3 |
| | Faces | | | | |
| | Core | Amino | 10 | | |
| 2 | Both | ncPF | 5.2 | 7.5 | 2.4 |
| | Faces | | | | |
| | Core | Amino | 10 | | |

The result show the commercial viability of boards prepared with face layers comprising ncPF and core layers comprising an amino resin. By preparing the board with about half the amount of ncPF resin used in the face layers as compared to the amount of amino resin used in the face layers, the formaldehyde emissions were reduced even at identical press times.

The following examples show that a board containing a hybrid resin binder composition formed by combining a ncPF resin and a melamine-urea-formaldehyde (amino) resin gives a reduction in formaldehyde emissions while retaining the mechanical properties of the board when compared to a board containing only the melamine-urea-formaldehyde (amino) resin binder.

### Example 9

### MUF Resin Preparation

A mUF resin was prepared to have a melamine content of 6.5% based on liquid resin. The molar ratio F:(NH₂)₂ was 1.0.

The resin had a viscosity of 220 mPas (25° C.), pH 9.9 and solids content 65%. The stability was >39 days to double viscosity at 25° C.

### Example 10

### MUF Resin Preparation

A mUF resin was prepared to have a melamine content of 24.5% based on liquid resin. The molar ratio F:(NH₂)₂ was 1.0.

The resin had a viscosity of 277 mPa·s (25° C.), pH 9.9 and solids content 66%. The stability was 26 days to double viscosity at 25° C.

### Example 11

### Production of MDF Boards by Using the MUF Resin of Example 9 as the Amino Resin in a Hybrid Amino/ncPF as Adhesive

Under the same running conditions, boards made with pure MUF resin were compared with boards made from a hybrid system. The specific press time was 12.5 s/mm. The MDF boards were single layer having a thickness of 10 mm with a density of 700 kg/m³ and they were pressed at 205° C. press plate temperature. The catalyst was mixed with the resin prior to application. The furnish was prepared by dry blending.

1) The MUF resin binder of Example 9 was used to prepare a single layer MDF. The resin was catalyzed with 1.0% ammonium sulfate hardener. The resin loading was 12% solid resin to dry fibers.

2) The MUF resin binder of Example 9 was mixed with the ncPF resin of Example 1 to prepare a hybrid resin composition. The hybrid resin composition was prepared by mixing the MUF resin binder of Example 9 with the ncPF resin of Example 1 in a ratio of 12:5.9 based on the solids content. The hybrid system was catalyzed with 1.0% ammonium sulfate. The resin loading was 12.0% of the MUF resin binder of Example 9 and 5.9% of ncPF resin of Example 1 totaling 17.9% solid resin to dry fibers. The results are shown in the following table.

| | | | | | | Perforator |
|---|---|---|---|---|---|---|
| | | | | | Internal bond | value at 6.5% |
| | | Resin loading | | Thickness | strength, dry, | m.c. |
| | | (solid | Specific | swelling | according to | according to |
| | | resin/solid | press time | according to | EN 319 | EN 120 |
| Board | Adhesive | fiber) | (s/mm) | EN 317 (24 h) | (N/mm²) | (mg/100 g) |
| 1 | MUF^{a} | 12.0% | 12.5 | 9.7 | 0.60 | 11.0 |
| 2 | MUF^{a}/ncPF^{b} | 12.0%/5.9% | 12.5 | 9.3 | 0.61 | 4.5 |

^{a}MUF resin binder of Example 9
^{b}ncPF resin binder of Example 1

### Example 12

### Production of MDF Boards by Using the MUF Resin of Example 10 as the Amino Resin in a Hybrid Amino/ncPF as Adhesive

Under the same running conditions, boards made with pure mUF resin were compared with boards made from a hybrid system. The specific press time was 12.5 s/mm. The MDF boards were a single layer having a thickness of 10 mm with a density of 700 kg/m³ and they were pressed at 205° C. press plate temperature. The catalyst was mixed with the resin prior to application. The furnish was prepared by dry blending.

1) The binder of Example 10 was used to prepare a single layer MDF. The resin was catalyzed with 1.0% ammonium sulfate hardener. The resin loading was 12% solid resin to dry fibers.

2) The MUF resin binder of Example 10 was mixed with the ncPF resin of Example 1 to prepare a hybrid resin composition. The hybrid resin composition was prepared by mixing the MUF resin binder of Example 10 with the ncPF resin of Example 1 in a ratio of 12:5.4 based on the solids content. The hybrid system was catalyzed with 1.0% ammonium sulfate. The resin loading was 12.0% of the MUF resin binder of Example 10 and 5.4% of ncPF resin of Example 1 totaling 17.4% solid resin to dry fibers. The results are shown in the following table.

| | | | | | | Perforator |
|---|---|---|---|---|---|---|
| | | Resin | | | Internal bond | value at 6.5% |
| | | loading | | Thickness | strength, dry, | m.c. |
| | | (solid | Specific | swelling | according to | according to |
| | | resin/solid | press time | according to | EN 319 | EN 120 |
| Board | Adhesive | fiber) | (s/mm) | EN 317 (24 h) | (N/mm²) | (mg/100 g) |
| 1 | MUF^{a} | 12.0% | 12.5 | 8.5 | 0.58 | 16.5 |
| 2 | MUF^{a}/ncPF^{b} | 12.0/5.4% | 12.5 | 8.5 | 0.58 | 4.3 |

^{a}MUF resin binder of Example 10
^{b}ncPF resin binder of Example 1

Examples 9-12 show that a board containing a hybrid resin binder composition formed by combining a ncPF resin and a melamine-urea-formaldehyde (amino) resin gives a reduction in formaldehyde emissions while retaining the mechanical properties of the board when compared to a board containing only the melamine-urea-formaldehyde (amino) resin binder.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1) A low formaldehyde emission resin composition which comprises a condensation product of a naturally occurring component or derivative thereof, an aromatic hydroxyl compound-aldehyde resin,
wherein said low formaldehyde emission resin composition further comprises an amino resin as part of said condensation product and/or as a component mixed therein,
wherein the naturally occurring component or derivative thereof is chemically bonded directly or indirectly to the aromatic hydroxyl compound-aldehyde resin (ncPF resin) and optionally the amino resin,
wherein the viscosity of the resin composition is 1 to 500 mPas as measured with a rotational viscosimeter at a shear rate of 1000 s⁻¹ and temperature 25° C. and the amount of solids in the resin composition is 45-75% as measured after heating using standard ASTM D-1490-93, and
wherein the naturally occurring component or derivative thereof comprises protein.

2) A low formaldehyde emission resin composition which comprises a condensation product of a naturally occurring component or derivative thereof, an aromatic hydroxyl compound-aldehyde resin and at least 20 wt % of urea based on the total mass of the resin composition,
wherein at least 50 wt % of the naturally occurring component or derivative thereof is chemically bonded directly or indirectly to the aromatic hydroxyl compound-aldehyde resin (ncPF),
wherein the viscosity of the resin composition is 1 to 500 mPas as measured with a rotational viscosimeter at a shear rate of 1000 s⁻¹ and temperature 25° C. and the amount of solids in the resin composition is 45-75% as measured after heating using standard ASTM D-1490-93, and
wherein the naturally occurring component or derivative thereof comprises protein.

3) A polymerizable resin composition which comprises an aromatic hydroxyl compound, an aldehyde compound and a naturally occurring component or derivative thereof comprising protein,
wherein the polymerizable resin composition is prepared in a process comprising combining said naturally occurring component or derivative thereof having a pH≦7 with the aromatic hydroxyl compound and aldehyde compound,
wherein the protein of the naturally occurring component or derivative thereof is water based.

4) The low formaldehyde emission resin composition according to claim 1, wherein the resin composition has a moderate pH of 7-10.

5) The low formaldehyde emission resin composition according to claim 2, wherein the resin composition has a moderate pH of 7-10.

6) The low formaldehyde emission resin composition according to claim 1, wherein the naturally occurring component or derivative thereof is an isolate from a plant source obtained by water extraction and optionally grinding/milling.

7) The low formaldehyde emission resin composition according to claim 2, wherein the naturally occurring component or derivative thereof is an isolate from a plant source obtained by water extraction and optionally grinding/milling.

8) The polymerizable resin composition according to claim 3, wherein the naturally occurring component or derivative thereof used to chemically bind to the aromatic hydroxyl compound-aldehyde resin is an isolate from a plant source obtained by water extraction and optionally grinding/milling.

9) The low formaldehyde emission resin composition according to claim 1, wherein the naturally occurring component or derivative thereof further comprises polyol and the polyol is a carbohydrate.

10) The polymerizable resin composition according to claim 3, wherein the naturally occurring component or derivative thereof further comprises polyol and the polyol is a carbohydrate.

11) The low formaldehyde emission resin composition according to claim 1, wherein the naturally occurring component or derivative thereof is from wheat and/or corn.

12) The low formaldehyde emission resin composition according to claim 2, wherein the naturally occurring component or derivative thereof is from wheat and/or corn.

13) The polymerizable resin composition according to claim 3, wherein the naturally occurring component or derivative thereof is from wheat and/or corn.

14) The low formaldehyde emission resin composition according to claim 1, wherein the molar ratio of nitrogen groups to aromatic hydroxyl groups in the resin composition is 1:0-0.25.

15) The low formaldehyde emission resin composition according to claim 2, wherein the molar ratio of nitrogen groups to aromatic hydroxyl groups in the resin composition is 1:0-0.25.

16) The low formaldehyde emission resin composition according to claim 1, further comprising an amino resin wherein the amino resin comprises melamine in a concentration of 0.1-65 wt % based on total weight of solids in the resin composition.

17) The low formaldehyde emission resin composition according to claim 2, further comprising an amino resin wherein the amino resin comprises melamine in a concentration of 0.1-65 wt % based on total weight of solids in the resin composition.

18) A process of forming a binder for lignocellulosic or cellulosic materials comprising:
combining a naturally occurring component or derivative thereof having a pH≦7, an aromatic hydroxyl compound, an aldehyde compound and a nitrogen compound in any order under conditions sufficient to result in the condensation of at least two of the naturally occurring component or derivative thereof, the aromatic hydroxyl compound, the aldehyde compound and the nitrogen compound together,
wherein the naturally occurring component or derivative thereof comprises a water-based protein.

19) The process of forming a binder for lignocellulosic or cellulosic materials according to claim 18, comprising combining the aromatic hydroxyl compound and the aldehyde compound in a first step to form an aromatic hydroxyl compound-aldehyde resin and then combining the naturally occurring component or derivative thereof with the aromatic hydroxyl compound-aldehyde resin in a second step to form a ncPF resin.

20) The process of forming a binder for lignocellulosic or cellulosic materials according to claim 19, fluffier comprising a step of obtaining the naturally occurring component or derivative thereof as an isolate through isolation from a plant source with water extraction and optional grinding/milling.

21) The process of forming a binder for lignocellulosic or cellulosic materials according to claim 18, comprising:
condensing an aldehyde compound with a nitrogen compound to form an amino resin in one batch,
condensing the naturally occurring component or derivative thereof with an aromatic hydroxyl compound and an aldehyde compound to form a ncPF resin in a second batch and
blending the two batches.

22) The process of forming a binder for lignocellulosic or cellulosic materials according to claim 18, further comprising a step of methylolating at least one of the naturally occurring component or derivative thereof, aromatic hydroxyl compound and nitrogen compound.

23) The process of forming a binder for lignocellulosic or cellulosic materials according to claim 18, comprising the following steps in order:
forming an aqueous media containing ncPF by condensing the aromatic hydroxyl compound, a first aldehyde compound and the naturally occurring component or derivative thereof,
forming the amino resin in situ by adding a second aldehyde compound and the nitrogen compound to the solution, wherein the second and first aldehyde compounds may be the same or different,
adjusting the pH to be neutral to slightly acidic,
condensing the solution with distillation to a viscosity of 50-3000 mPas as measured with a rotational viscosimeter at a shear rate of 1000 s⁻¹ and temperature 25° C.,
and if the solids are not at least 50 wt % based on the total weight of the solution, then performing an additional step of adding more ncPF, nitrogen compound, aldehyde compound and/or amino resin to the solution to raise the solids to at least 50 wt % based on the total weight of the solution,
wherein the naturally occurring component or derivative thereof comprises protein.

24) The process of forming a binder for lignocellulosic or cellulosic materials according to claim 18, wherein the binder product has a pH of 7-10.

25) A lignocellulosic or cellulosic material product comprising a lignocellulosic or cellulosic material and the low formaldehyde emission resin composition according to claim 1.

26) A lignocellulosic or cellulosic material product comprising a lignocellulosic or cellulosic material and the low formaldehyde emission resin composition according to claim 2.

27) The lignocellulosic or cellulosic material product according to claim 25, wherein the multilayer or single layer substrate is a composite board, plywood, parquet, LVL, wood lamination, board on frame, or impregnated paper.

28) The lignocellulosic or cellulosic material product according to claim 26, wherein the multilayer or single layer substrate is a composite board, plywood, parquet, LVL, wood lamination, board on frame, or impregnated paper.

29) A composite board comprising the low formaldehyde emission resin composition according to claim 1;
wherein the composite board has a low formaldehyde emission of 0.01 to 0.5 mg/L according to JIS A1460, issued March 2001;
wherein when the composite board is a particle board, the particle board meets the mechanical and swelling properties according to standard EN 312, issued October 2003;
wherein when the composite board is a fiberboard, the fiberboard meets the mechanical and swelling properties according to standard EN 622-1 issued June 2003;
wherein when the composite board is a MDF, the MDF meets the mechanical and swelling properties according to standard EN 622-5 issued December 1997; and
wherein when the composite board is an oriented strand board, the oriented strand board meets the mechanical and swelling properties according to standard EN 300, issued September 1997.

30) A composite board comprising the low formaldehyde emission resin composition according to claim 2;
wherein the composite board has a low formaldehyde emission of 0.01 to 0.5 mg/L according to JIS A1460, issued March 2001;
wherein when the composite board is a particle board, the particle board meets the mechanical and swelling properties according to standard EN 312, issued October 2003;
wherein when the composite board is a fiberboard, the fiberboard meets the mechanical and swelling properties according to standard EN 622-1 issued June 2003;
wherein when the composite board is a MDF, the MDF meets the mechanical and swelling properties according to standard EN 622-5 issued December 1997; and
wherein when the composite board is an oriented strand board, the oriented strand board meets the mechanical and swelling properties according to standard EN 300, issued September 1997.

31) A wood based panel comprising:
layer (X) comprising the low formaldehyde emission resin composition according to claim 1, and
layer (Y) comprising a binder other than said binder in layer (X).

32) The wood based panel according to claim 31, wherein the binder in said layer (Y) comprises an amino resin.

33) A low density board having a density of <800 kg/m³ comprising the low formaldehyde emission resin composition according to claim 1 as a binder.
